(19) United States
(12) Patent Application Publication
(10) Pub. No.: US 2026/0085451 A1
(43) Pub. Date: Mar. 26, 2026

(54) METHOD OF MAKING POLYHYDROXYALKANOATE YARN AND FABRIC AND ARTICLE COMPRISING THE SAME

(71) Applicant: NEOX Public Benefit LLC, New York, NY (US)

(72) Inventors: Neri Oxman, New York, NY (US); Markus A.R. Kayser, New York, NY (US); Luis Ruben Soenksen Martinez, New York, NY (US); Jessica Lu, New York, NY (US); Andrea H. Westlie, New York, NY (US)

(21) Appl. No.: 19/340,127

(22) Filed: Sep. 25, 2025

Related U.S. Application Data
(60) Provisional application No. 63/698,686, filed on Sep. 25, 2024.

(51) Int. Cl. D01D 5/088; C08G 63/06; D01F 6/62; D02G 3/02; D03D 15/283; D03D 15/573; D04B 1/16; D04B 21/00

(52) U.S. Cl. CPC D01D 5/088; C08G 63/06; D01F 6/625; D02G 3/02; D03D 15/283; D03D 15/573; D04B 1/16; D04B 21/00; D10B 2331/04; D10B 2401/063

(57) ABSTRACT

A method of making a polyhydroxyalkanoate yarn comprising a polyhydroxyalkanoate fiber is disclosed. The method comprises extruding a polymer melt comprising a polyhydroxyalkanoate composition comprising a polyhydroxyalkanoate through a spinneret, withdrawing a fiber from the spinneret, quenching the fiber, and collecting the fiber on a winding roller. The yarn exhibits an elongation at break of 50% or more to 1000% or less and a tenacity of 0.1 g/d or more to 4 g/d or less. A polyhydroxyalkanoate yarn comprising a polyhydroxyalkanoate fiber is also disclosed.

### CROSS-REFERENCE TO RELATED APPLICATION

The present application claims filing benefit of U.S. Provisional Ser. No. 63/698,686 having a filing date of Sep. 25, 2024, which is hereby incorporated by reference in its entirety.

### BACKGROUND

Polymers, whether natural or synthetic, are often used in numerous and diverse applications. Particularly, polyesters, such as polyhydroxyalkanoates, may be utilized in various applications due to the ability to tailor the properties of the specific polyesters for a given application. As one example, such polyesters may be utilized for articles, including apparel and garments, due to their properties and processing capabilities. However, to form such articles, the polyesters need to be spun and may, at times, have a propensity to break during spinning. Such breakage can affect the resulting properties of the resulting fabric and article as well as impact the aesthetic characteristics of such fabric and article.

As such, a need currently exists for providing a polyhydroxyalkanoate yarn and an improved method of making a polyhydroxyalkanoate yarn and resulting fabric and article including the polyhydroxyalkanoate yarn.

### SUMMARY OF THE DISCLOSURE

In accordance with one embodiment of the present disclosure, a method of making a polyhydroxyalkanoate yarn comprising a polyhydroxyalkanoate fiber is disclosed. The polyhydroxyalkanoate fiber formed by a method comprising extruding a polymer melt comprising a polyhydroxyalkanoate composition comprising a polyhydroxyalkanoate through a spinneret, withdrawing a fiber from the spinneret, quenching the fiber, and collecting the fiber on a winding roller. The yarn exhibits an elongation at break of 50% or more to 1000% or less and a tenacity of 0.1 g/d or more to 4 g/d or less.

In accordance with another embodiment of the present disclosure, a polyhydroxyalkanoate yarn is disclosed. The polyhydroxyalkanoate yarn comprises a polyhydroxyalkanoate fiber made by extruding a polymer melt comprising a polyhydroxyalkanoate composition comprising a polyhydroxyalkanoate through a spinneret, withdrawing a fiber from the spinneret, quenching the fiber, and collecting the fiber on a winding roller. The yarn exhibits an elongation at break of 50% or more to 1000% or less and a tenacity of 0.1 g/d or more to 4 g/d or less.

In accordance with another embodiment of the present disclosure, a polyhydroxyalkanoate-based fabric is disclosed. The polyhydroxyalkanoate-based fabric comprises a polyhydroxyalkanoate yarn. The polyhydroxyalkanoate yarn comprises a polyhydroxyalkanoate fiber made by extruding a polymer melt comprising a polyhydroxyalkanoate composition comprising a polyhydroxyalkanoate through a spinneret, withdrawing a fiber from the spinneret, quenching the fiber, and collecting the fiber on a winding roller. The yarn exhibits an elongation at break of 50% or more to 1000% or less and a tenacity of 0.1 g/d or more to 4 g/d or less.

In accordance with another embodiment of the present disclosure, a polyhydroxyalkanoate yarn is disclosed. The yarn comprises a polyhydroxyalkanoate fiber comprising a polyhydroxyalkanoate composition comprising a polyhydroxyalkanoate, wherein the yarn exhibits an elongation at break of 50% or more to 1000% or less and a tenacity of 0.1 g/d or more to 4 g/d or less.

Other features and aspects of the present disclosure are set forth in greater detail below.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a method of making a polyhydroxyalkanoate yarn as well as a polyhydroxyalkanoate fiber and polyhydroxyalkanoate-based fabric comprising the same. The present inventors have discovered a method that allows for the manufacture of a polyhydroxyalkanoate yarn and fiber that is primarily comprised of a polyhydroxyalkanoate. By providing such a yarn and fiber, the manufacturing process may be simpler due to the ability to process the polyhydroxyalkanoate without the inclusion of a considerable amount of other types of polymer.

Accordingly, of the polymers present in the polyhydroxyalkanoate yarn and/or fiber and the polyhydroxyalkanoate composition as disclosed herein for making the polyhydroxyalkanoate yarn and/or fiber, the polyhydroxyalkanoate(s) may constitute a primary concentration of such respective yarn and/or fiber and composition. For instance, in one embodiment, of the polymers present, the polyhydroxyalkanoate(s) may constitute 80 wt. % or more, such as 85 wt. % or more, such as 90 wt. % or more, such as 92 wt. % or more, such as 94 wt. % or more, such as 95 wt. % or more, such as 96 wt. % or more, such as 97 wt. % or more, such as 98 wt. % or more, such as 98.5 wt. % or more, such as 99 wt. % or more, such as 99.5 wt. % or more, such as 99.8 wt. % or more, such as 99.9 wt. % or more, such as 99.99 wt. % or more of the polymers present, whether in such polyhydroxyalkanoate yarn and/or fiber or the polyhydroxyalkanoate composition. In some embodiments, the polyhydroxyalkanoate(s) may constitute 100 wt. % of the polymers present in the polyhydroxyalkanoate yarn and/or fiber and the polyhydroxyalkanoate composition.

Further, the present inventors have discovered the polyhydroxyalkanoate and corresponding composition as well as the process disclosed herein for making a polyhydroxyalkanoate fiber and/or yarn can result in the formation of a polyhydroxyalkanoate fiber and/or yarn having desired properties. In particular, the materials and fibers/yarns disclosed herein exhibit a relatively amorphous structure. In addition, the fibers/yarns disclosed herein may be generally flexible and/or elastomeric in nature.

Further, the fiber/filament and/or corresponding yarn may exhibit desired mechanical properties and strength. For instance, the tensile strength may be about 25 MPa or more, such as about 50 MPa or more, such as about 75 MPa or more, such as about 100 MPa or more, such as about 125 MPa or more, such as about 150 MPa or more, such as about 175 MPa or more, such as about 200 MPa or more, such as about 225 MPa or more, such as about 250 MPa or more, such as about 275 MPa or more, such as about 300 MPa or more, such as about 325 MPa or more, such as about 350 MPa or more, such as about 375 MPa or more, such as about 400 MPa or more. The tensile strength may be about 1000 MPa or less, such as about 950 MPa or less, such as about 900 MPa or less, such as about 850 MPa or less, such as about 800 MPa or less, such as about 750 MPa or less, such as about 700 MPa or less, such as about 650 MPa or less, such as about 600 MPa or less, such as about 575 MPa or less, such as about 550 MPa or less, such as about 525 MPa or less, such as about 500 MPa or less, such as about 475 MPa or less, such as about 450 MPa or less, such as about 425 MPa or less, such as about 400 MPa or less, such as about 375 MPa or less, such as about 350 MPa or less, such as about 325 MPa or less. The tensile strength may be determined in accordance with ASTM D2653-07(2018) (30 mm gauge length, 100 mm/min strain rate) at a temperature of about 23° C.

In addition, the elongation at break of the fiber/filament and/or yarn as disclosed herein may be about 5% or more, such as about 10% or more, such as about 15% or more, such as about 20% or more, such as about 25% or more, such as about 50% or more, such as about 75% or more, such as about 100% or more, such as about 125% or more, such as about 150% or more, such as about 175% or more, such as about 200% or more, such as about 225% or more, such as about 250% or more, such as about 275% or more, such as about 300% or more, such as about 325% or more, such as about 350% or more, such as about 375% or more, such as about 400% or more, such as about 450% or more, such as about 500% or more, such as about 600% or more, such as about 800% or more. The elongation at break may be about 1000% or less, such as about 900% or less, such as about 800% or less, such as about 700% or less, such as about 600% or less, such as about 550% or less, such as about 500% or less, such as about 475% or less, such as about 450% or less, such as about 425% or less, such as about 400% or less, such as about 375% or less, such as about 350% or less, such as about 325% or less, such as about 300% or less, such as about 275% or less, such as about 250% or less. The elongation at break may be determined in accordance with ASTM D2653-07(2018) at a temperature of about 23° C.

In addition to the elongation at break, the fiber/filament and/or corresponding yarn as disclosed herein may also exhibit a desired strength as indicated by the tenacity. For instance, the tenacity may be about 0.1 grams per denier (g/d) or more, such as about 0.2 g/d or more, such as about 0.3 g/d or more, such as about 0.4 g/d or more, such as about 0.5 g/d or more, such as about 0.6 g/d or more, such as about 0.7 g/d or more, such as about 0.8 g/d or more, such as about 0.85 g/d or more, such as about 0.9 g/d or more, such as about 0.95 g/d or more, such as about 1 g/d or more, such as about 1.05 g/d or more, such as about 1.1 g/d or more, such as about 1.15 g/d or more, such as about 1.2 g/d or more, such as about 1.25 g/d or more, such as about 1.3 g/d or more, such as about 1.35 g/d or more, such as about 1.4 g/d or more, such as about 1.45 g/d or more, such as about 1.5 g/d or more, such as about 1.6 g/d or more, such as about 1.8 g/d or more, such as about 2 g/d or more. The tenacity may be about 5 g/d or less, such as about 4 g/d or less, such as about 3.5 g/d or less, such as about 3 g/d or less, such as about 2.5 g/d or less, such as about 2 g/d or less, such as about 1.8 g/d or less, such as about 1.6 g/d or less, such as about 1.4 g/d or less, such as about 1.2 g/d or less, such as about 1.15 g/d or less, such as about 1.1 g/d or less, such as about 1.05 g/d or less, such as about 1 g/d or less. The tenacity may be determined in accordance with ASTM D2653-07(2018) at a temperature of about 23° C.

Various embodiments of the present disclosure will now be described in more detail.

### I. Polyhydroxyalkanoate Composition

As indicated herein, the fibers and/or yarns are made from a polyhydroxyalkanoate. In one embodiment, such fibers and/or yarns may be made from a polyhydroxyalkanoate composition comprising a polyhydroxyalkanoate. In addition, the polyhydroxyalkanoate composition may also include other additives as generally known in the art.

### A. Polyhydroxyalkanoate

As indicated above, the polyhydroxyalkanoate composition includes a polyhydroxyalkanoate. Without intending to be limited, polyhydroxyalkanoates are generally biodegradable polyesters. The polyhydroxyalkanoate may be one as generally known in the art.

The polyhydroxyalkanoate may be produced biologically or synthetically. In one embodiment, the polyhydroxyalkanoate may be a biologically produced polyhydroxyalkanoate. For instance, such polyhydroxyalkanoate may be produced by certain bacteria, which are not necessarily limited by the present disclosure. In particular, such polyhydroxyalkanoate may be produced, although not limited, by fermentation processes. In another embodiment, the polyhydroxyalkanoate may be a synthetically produced polyhydroxyalkanoate. For instance, such polyhydroxyalkanoate may be produced by chemically reacting respective monomers for the synthesis of the polyhydroxyalkanoate.

Further, the polyhydroxyalkanoate may be a homopolymer or a copolymer. In one embodiment, the polyhydroxyalkanoate may be a homopolymer. In another embodiment, the polyhydroxyalkanoate may be a copolymer.

The polyhydroxyalkanoate may comprise one or more monomeric units. In general, the monomeric unit may have the following formula:

—OCR¹R²(CR³R⁴)ₙCO—

wherein

n is an integer; and

R¹, R², R³, and R⁴ independently can be hydrocarbon radicals; halo- and hydroxy-substituted radicals; hydroxy radicals; halogen radicals; nitrogen-substituted radicals; oxygen-substituted radicals; and/or hydrogen atoms.

As indicated above, “n” is an integer. For instance, “n” may be from 1 to 15, such as from 1 to 10, such as from 1 to 8, such as from 1 to 5, such as from 1 to 4, such as from 1 to 3, such as from 1 to 2, such as 1. In this regard, “n” may be 1 or more, such as 2 or more, such as 3 or more. Also, “n” may be 15 or less, such as 12 or less, such as 10 or less, such as 8 or less, such as 6 or less, such as 5 or less, such as 4 or less, such as 3 or less, such as 2 or less. In one embodiment, “n” may be 1. Such embodiments may correspond to 3-hydroxyacids. In another embodiment, “n” may be 2. Such embodiments may correspond to 4-hydroxyacids. In another embodiment, “n”may be 3. Such embodiments may correspond to 5-hydroxyacids.

As indicated above, R¹, R², R³, and R⁴ independently can be a hydrocarbon radical; a halo-and hydroxy-substituted radical; a hydroxy radical; a halogen radical; a nitrogen-substituted radical; an oxygen-substituted radical; or a hydrogen atom. For example, R¹, R², R³, and R⁴ independently can be a hydrocarbon radical or a hydrogen atom. In one embodiment, a respective R group may be a hydrogen atom. In another embodiment, a respective R group may be a hydrocarbon radical.

The hydrocarbon radical may be an alkyl radical. The alkyl radical may be a C₁-C₂₀ alkyl radical, such as a C₁-C₁₆ alkyl radical, such as a C₁-C₁₂ alkyl radical, such as a C₁-C₈ alkyl radical, such as a C₁-C₆ alkyl radical, such as a C₁-C₄ alkyl radical, such as a C₁-C₂ alkyl radical, such as a C₁ alkyl radical. For instance, such radical may have 1 or more, such as 2 or more, such as 3 or more, such as 4 or more, such as 5 or more, such as 6 or more carbon atoms. Such alkyl radical may have 20 or less, such as 18 or less, such as 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, such alkyl radical may have 1 carbon atom such that it is a methyl group.

The polyhydroxyalkanoate may comprise one or more monomeric units including, but not limited to, 2-hydroxybutyrate, glycolic acid, 3-hydroxybutyrate, 3-hydroxypropionate, 3-hydroxyvalerate, 3-hydroxyhexanoate, 3-hydroxyheptanoate, 3-hydroxyoctanoate, 3-hydroxynonanoate, 3-hydroxydecanoate, 3-hydroxydodecanoate, 4-hydroxybutyrate, 4-hydroxyvalerate, 5-hydroxyvalerate, 6-hydroxyhexanoate, and mixtures thereof. However, it should be understood that the polyhydroxyalkanoate may also include other monomeric units not expressly recited herein.

As indicated herein, in one embodiment, the polyhydroxyalkanoate may be a homopolymer. The homopolymer may include a hydroxyalkanoate monomeric unit, such as one having a monomeric unit as described above.

Examples of polyhydroxyalkanoate homopolymers may include, but are not limited to, poly-3-hydroxyalkanoates (e.g., poly-3-hydroxypropionate (P3HP), poly-3-hydroxybutyrate (P3HB), poly-3-hydroxyvalerate (P3HV), poly-3-hydroxyhexanoate (P3HH), poly-3-hydroxyoctanoate (P3HO), poly-3-hydroxydecanoate (P3HD), and poly-3-hydroxy-5-phenylvalerate (P3H5PV)), poly-4-hydroxyalkanoates (e.g., poly-4-hydroxybutyrate (P4HB) and poly-4-hydroxyvalerate (P4HV)), and poly-5-hydroxyalkanoates (e.g., poly-5-hydroxyvalerate (P5HV)), etc. In one embodiment, the polyhydroxyalkanoate may be a poly 3-hydroxyalkanoate. For instance, in one embodiment, the polyhydroxyalkanoate may be poly-3-hydroxybutyrate (P3HB). In another embodiment, the polyhydroxyalkanoate may be poly-3-hydroxypropionate (P3HP).

As also indicated herein, the polyhydroxyalkanoate may be a copolymer. The copolymer may include at least one hydroxyalkanoate monomeric unit, such as one having a monomeric unit as described above. In one embodiment, the copolymer may include at least two hydroxyalkanoate monomeric units, such as those having a monomeric unit as described above. In one particular embodiment, the copolymer may include at least a 3-hydroxybutyrate monomeric unit.

Examples of polyhydroxyalkanoate copolymers may include, but are not limited to, poly-3-hydroxybutyrate-co-3-hydroxypropionate (P3HB3HP), poly-3-hydroxybutyrate-co-4-hydroxybutyrate (P3HB4HB), poly-3-hydroxybutyrate-co-4-hydroxyvalerate (P3HB4HV), poly-3-hydroxybutyrate-co-3-hydroxyvalerate (P3HB3HV), poly-3-hydroxybutyrate-co-3-hydroxyhexanoate (P3HB3HH), poly-3-hydroxybutyrate-co-5-hydroxyvalerate (P3HB5HV), etc. In one embodiment, the polyhydroxyalkanoate may be poly-3-hydroxybutyrate-co-4-hydroxybutyrate (P3HB4HB). In another embodiment, the polyhydroxyalkanoate may be poly-3-hydroxybutyrate-co-3-hydroxyhexanoate (P3HB3HH).

When the polyhydroxyalkanoate is a copolymer, the monomeric composition is not necessarily limited by the present disclosure. For instance, a first monomeric unit may be present in an amount of greater than 0 mol %, such as 0.1 mol % or more, such as 0.2 mol % or more, such as 0.5 mol % or more, such as 1 mol % or more, such as 2 mol % or more, such as 3 mol % or more, such as 5 mol % or more, such as 8 mol % or more, such as 10 mol % or more, such as 15 mol % or more, such as 20 mol % or more, such as 25 mol % or more, such as 30 mol % or more, such as 35 mol % or more, such as 40 mol % or more, such as 45 mol % or more, such as 50 mol % or more, such as 55 mol % or more, such as 60 mol % or more, such as 65 mol % or more, such as 70 mol % or more, such as 75 mol % or more, such as 80 mol % or more, such as 85 mol % or more, such as 90 mol % or more, such as 93 mol % or more, such as 95 mol % or more, such as 96 mol % or more, such as 97 mol % or more, such as 98 mol % or more, such as 99 mol % or more, such as 99.5 mol % or more based on the total monomeric units of the polyhydroxyalkanoate. The first monomeric unit may be present in an amount of less than 100 mol %, such as 99.9 mol % or less, such as 99.8 mol % or less, such as 99.7 mol % or less, such as 99.5 mol % or less, such as 99 mol % or less, such as 98 mol % or less, such as 97 mol % or less, such as 96 mol % or less, such as 95 mol % or less, such as 93 mol % or less, such as 90 mol % or less, such as 85 mol % or less, such as 80 mol % or less, such as 75 mol % or less, such as 70 mol % or less, such as 65 mol % or less, such as 60 mol % or less, such as 55 mol % or less, such as 50 mol % or less, such as 45 mol % or less, such as 40 mol % or less, such as 35 mol % or less, such as 30 mol % or less, such as 25 mol % or less, such as 20 mol % or less, such as 15 mol % or less, such as 10 mol % or less, such as 8 mol % or less, such as 5 mol % or less, such as 4 mol % or less, such as 3 mol % or less, such as 2 mol % or less, such as 1 mol % or less, such as 0.8 mol % or less, such as 0.5 mol % or less, such as 0.3 mol % or less, such as 0.2 mol % or less, such as 0.1 mol % or less based on the total monomeric units of the polyhydroxyalkanoate. In some embodiments, the first monomeric unit may be 3-hydroxybutyrate.

Similarly, a second monomeric unit may be present in an amount of greater than 0 mol %, such as 0.1 mol % or more, such as 0.2 mol % or more, such as 0.5 mol % or more, such as 1 mol % or more, such as 2 mol % or more, such as 3 mol % or more, such as 5 mol % or more, such as 8 mol % or more, such as 10 mol % or more, such as 15 mol % or more, such as 20 mol % or more, such as 25 mol % or more, such as 30 mol % or more, such as 35 mol % or more, such as 40 mol % or more, such as 45 mol % or more, such as 50 mol % or more, such as 55 mol % or more, such as 60 mol % or more, such as 65 mol % or more, such as 70 mol % or more, such as 75 mol % or more, such as 80 mol % or more, such as 85 mol % or more, such as 90 mol % or more, such as 93 mol % or more, such as 95 mol % or more, such as 96 mol % or more, such as 97 mol % or more, such as 98 mol % or more, such as 99 mol % or more, such as 99.5 mol % or more based on the total monomeric units of the polyhydroxyalkanoate. The second monomeric unit may be present in an amount of less than 100 mol %, such as 99.9 mol % or less, such as 99.8 mol % or less, such as 99.7 mol % or less, such as 99.5 mol % or less, such as 99 mol % or less, such as 98 mol % or less, such as 97 mol % or less, such as 96 mol % or less, such as 95 mol % or less, such as 93 mol % or less, such as 90 mol % or less, such as 85 mol % or less, such as 80 mol % or less, such as 75 mol % or less, such as 70 mol % or less, such as 65 mol % or less, such as 60 mol % or less, such as 55 mol % or less, such as 50 mol % or less, such as 45 mol % or less, such as 40 mol % or less, such as 35 mol % or less, such as 30 mol % or less, such as 25 mol % or less, such as 20 mol % or less, such as 15 mol % or less, such as 10 mol % or less, such as 8 mol % or less, such as 5 mol % or less, such as 4 mol % or less, such as 3 mol % or less, such as 2 mol % or less, such as 1 mol % or less, such as 0.8 mol % or less, such as 0.5 mol % or less, such as 0.3 mol % or less, such as 0.2 mol % or less, such as 0.1 mol % or less based on the total monomeric units of the polyhydroxyalkanoate. In some embodiments, the second monomeric unit may be 3-hydroxyhexanoate.

Furthermore, the polyhydroxyalkanoate composition may include one or more polyhydroxyalkanoates. In particular, it should be understood that a mixture of two or more polyhydroxyalkanoates may be utilized. Such mixture may include at least two homopolymers, at least two copolymers, at least one homopolymer and at least one copolymer, etc. In one embodiment, the composition may contain one polyhydroxyalkanoate. In other embodiments, the composition may include a mixture of polyhydroxyalkanoates. For instance, more than one polyhydroxyalkanoate, such as two or three polyhydroxyalkanoates, may be utilized in the composition.

When multiple polyhydroxyalkanoates are utilized, the amount of each is not necessarily limited by the present disclosure. For instance, a first polyhydroxyalkanoate may be present in an amount of greater than 0 wt. %, such as 0.1 wt. % or more, such as 0.2 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 93 wt. % or more, such as 95 wt. % or more, such as 96 wt. % or more, such as 97 wt. % or more, such as 98 wt. % or more, such as 99 wt. % or more, such as 99.5 wt. % or more based on the total weight of the polyhydroxyalkanoates. The first polyhydroxyalkanoate may be present in an amount of less than 100 wt. %, such as 99.9 wt. % or less, such as 99.8 wt. % or less, such as 99.7 wt. % or less, such as 99.5 wt. % or less, such as 99 wt. % or less, such as 98 wt. % or less, such as 97 wt. % or less, such as 96 wt. % or less, such as 95 wt. % or less, such as 93 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.1 wt. % or less based on the total weight of the polyhydroxyalkanoates.

Similarly, a second polyhydroxyalkanoate may be present in an amount of greater than 0 wt. %, such as 0.1 wt. % or more, such as 0.2 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 93 wt. % or more, such as 95 wt. % or more, such as 96 wt. % or more, such as 97 wt. % or more, such as 98 wt. % or more, such as 99 wt. % or more, such as 99.5 wt. % or more based on the total weight of the polyhydroxyalkanoates. The second polyhydroxyalkanoate may be present in an amount of less than 100 wt. %, such as 99.9 wt. % or less, such as 99.8 wt. % or less, such as 99.7 wt. % or less, such as 99.5 wt. % or less, such as 99 wt. % or less, such as 98 wt. % or less, such as 97 wt. % or less, such as 96 wt. % or less, such as 95 wt. % or less, such as 93 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.1 wt. % or less based on the total weight of the polyhydroxyalkanoates.

Regarding the properties of the polyhydroxyalkanoate, it may be desired to have a melt flow that can allow for it to be processed in a relatively easy manner for the formation of a composition and resulting article as disclosed herein. In this regard, the polyhydroxyalkanoate may exhibit a relatively low melt viscosity as indicated by the melt flow rate. For instance, the melt flow rate of the polyhydroxyalkanoate may be about 0.5 g/10 min or more, such as about 1 g/10 min or more, such as about 2 g/10 min or more, such as about 3 g/10 min or more, such as about 4 g/10 min or more, such as about 5 g/10 min or more, such as about 7 g/10 min or more, such as about 10 g/10 min or more. The melt flow rate may be about 20 g/10 min or less, such as about 18 g/10 min or less, such as about 15 g/10 min or less, such as about 13 g/10 min or less, such as about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO 1133-1:2022.

The polyhydroxyalkanoate may also have a relatively low melting temperature. For instance, the melting temperature may be about 40° C. or more, such as about 50° C. or more, such as about 60° C. or more, such as about 70° C. or more, such as about 80° C. or more, such as about 90° C. or more, such as about 100° C. or more, such as about 110° C. or more, such as about 120° C. or more, such as about 130° C. or more, such as about 140° C. or more, such as about 150° C. or more, such as about 160° C. or more, such as about 170° C. or more, such as about 180° C. or more. The melting temperature may be about 200° C. or less, such as about 190° C. or less, such as about 180° C. or less, such as about 170° C. or less, such as about 160° C. or less, such as about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 50° C. or less. The melting temperature may be determined using means known in the art, such as differential scanning calorimetry in accordance with ISO 11357-1:2023 at a rate of 5°C./min.

In addition, the glass transition temperature of the polyhydroxyalkanoate may be within a particular range. For instance, the glass transition temperature may be about −60° C. or more, such as about −50° C. or more, such as about −40° C. or more, such as about −30° C. or more, such as about −20° C. or more, such as about −10° C. or more, such as about 0° C. or more, such as about 10° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more, such as about 100° C. or more, such as about 110° C. or more. The glass transition temperature may be about 120° C. or less, such as about 110° C. or less, such as about 100° C. or less, such as about 90° C. or less, such as about 80° C. or less, such as about 70° C. or less, such as about 60° C. or less, such as about 50° C. or less, such as about 40° C. or less, such as about 30° C. or less, such as about 20° C. or less, such as about 10° C. or less, such as about 0° C. or less, such as about 10°°C. or less, such as about −20° C. or less, such as about −30° C. or less, such as about 40°°C. or less, such as about −50° C. or less. The glass transition temperature may be determined using means known in the art, such as differential scanning calorimetry in accordance with ISO 11357-1:2023 at a rate of 5°C./min.

Aside from thermal behavior, the polyhydroxyalkanoate may have certain other properties and characteristics. For instance, the polyhydroxyalkanoate may have a particular density. For instance, the density may be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The polyhydroxyalkanoate may have a density of about 1.5 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019.

In addition, the polyhydroxyalkanoate may have a certain number average molecular weight. For instance, the number average molecular weight may be 10,000 g/mol or more, such as 20,000 g/mol or more, such as 30,000 g/mol or more, such as 50,000 g/mol or more, such as 80,000 g/mol or more, such as 100,000 g/mol or more, such as 150,000 g/mol or more, such as 200,000 g/mol or more, such as 300,000 g/mol or more, such as 400,000 g/mol or more, such as 500,000 g/mol or more. The number average molecular weight may be 2,000,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 250,000 g/mol or less, such as 200,000 g/mol or less, such as 150,000 g/mol or less, such as 120,000 g/mol or less, such as 100,000 g/mol or less. The number average molecular weight may be determined using means generally known in the art, such as gel permeation chromatography.

Similarly, the weight average molecular weight may be 10,000 g/mol or more, such as 20,000 g/mol or more, such as 30,000 g/mol or more, such as 50,000 g/mol or more, such as 80,000 g/mol or more, such as 100,000 g/mol or more, such as 150,000 g/mol or more, such as 200,000 g/mol or more, such as 300,000 g/mol or more, such as 400,000 g/mol or more, such as 500,000 g/mol or more. The weight average molecular weight may be 2,000,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 250,000 g/mol or less, such as 200,000 g/mol or less, such as 150,000 g/mol or less, such as 120,000 g/mol or less, such as 100,000 g/mol or less. The weight average molecular weight may be determined using means generally known in the art, such as gel permeation chromatography.

The polydispersity of the polyhydroxyalkanoate may be 1 or more, such as 1.1 or more, such as 1.2 or more, such as 1.3 or more, such as 1.4 or more, such as 1.5 or more, such as 1.6 or more, such as 1.7 or more, such as 1.8 or more, such as 1.9 or more, such as 2 or more. The polydispersity may be 5 or less, such as 4.8 or less, such as 4.5 or less, such as 4.3 or less, such as 4 or less, such as 3.8 or less, such as 3.5 or less, such as 3.3 or less, such as 3 or less, such as 2.8 or less, such as 2.6 or less, such as 2.5 or less, such as 2.4 or less, such as 2.3 or less, such as 2.2 or less, such as 2.1 or less, such as 2 or less, such as 1.9 or less, such as 1.8 or less, such as 1.7 or less, such as 1.6 or less.

In addition, the polyhydroxyalkanoate utilized may exhibit a certain mechanical strength. For instance, the tensile strength may be 1 MPa or more, such as 2 MPa or more, such as 3 MPa or more, such as 4 MPa or more, such as 5 MPa or more, such as 8 MPa or more, such as 10 MPa or more, such as 13 MPa or more, such as 15 MPa or more, such as 18 MPa or more, such as 20 MPa or more, such as 23 MPa or more, such as 25 MPa or more, such as 28 MPa or more, such as 30 MPa or more, such as 33 MPa or more, such as 35 MPa or more, such as 38 MPa or more, such as 40 MPa or more, such as 43 MPa or more, such as 45 MPa or more, such as 48 MPa or more. The tensile strength may be 50 MPa or less, such as 48 MPa or less, such as 45 MPa or less, such as 43 MPa or less, such as 40 MPa or less, such as 38 MPa or less, such as 35 MPa or less, such as 33 MPa or less, such as 30 MPa or less, such as 28 MPa or less, such as 25 MPa or less, such as 23 MPa or less, such as 20 MPa or less, such as 18 MPa or less, such as 15 MPa or less, such as 13 MPa or less, such as 10 MPa or less, such as 8 MPa or less, such as 5 MPa or less, such as 3 MPa or less. The tensile strength may be determined in accordance with ASTM D638-14 (Type V dogbone) at a temperature of about 23° C.

In addition, the tensile modulus may be about 0.1 GPa or more, such as 0.2 GPa or more, such as 0.3 GPa or more, such as 0.4 GPa or more, such as 0.5 GPa or more, such as 0.8 GPa or more, such as 1 GPa or more, such as 1.2 GPa or more, such as 1.4 GPa or more, such as 1.6 GPa or more, such as 1.8 GPa or more, such as 2 GPa or more. The tensile modulus may be 3 GPa or less, such as 2.8 GPa or less, such as 2.5 GPa or less, such as 2.3 GPa or less, such as 2 GPa or less, such as 1.8 GPa or less, such as 1.5 GPa or less, such as 1.3 GPa or less, such as 1 GPa or less, such as 0.8 GPa or less, such as 0.5 GPa or less, such as 0.3 GPa or less. The tensile modulus may be determined in accordance with ASTM D638-14 (Type V dogbone) at a temperature of about 23° C.

Also, the polyhydroxyalkanoate may have a relatively low strain at break. The strain at break may be about 0.3% or more, such as 0.5% or more, such as 0.8% or more, such as 1% or more, such as 1.3% or more, such as 1.5% or more, such as 1.8% or more, such as 2% or more, such as 2.5% or more, such as 3% or more, such as 3.5% or more, such as 4% or more, such as 5% or more, such as 6% or more, such as 7% or more, such as 8% or more, such as 9% or more, such as 10% or more, such as 11% or more, such as 12% or more, such as 13% or more, such as 15% or more, such as 18% or more, such as 20% or more, such as 23% or more, such as 25% or more, such as 30% or more. The strain at break may be 50% or less, such as 45% or less, such as 40% or less, such as 35% or less, such as 30% or less, such as 25% or less, such as 23% or less, such as 20% or less, such as 18% or less, such as 15% or less, such as 13% or less, such as 10% or less, such as 9% or less, such as 8% or less, such as 7% or less, such as 6% or less, such as 5% or less, such as 4% or less, such as 3% or less, such as 2% or less, such as 1% or less. The strain at break may be determined in accordance with ASTM D638-14 (Type V dogbone) at a temperature of about 23° C.

The polyhydroxyalkanoate composition may generally comprise about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 98 wt. % or more, such as about 99 wt. % or more of the polyhydroxyalkanoate(s) based on the weight of the polyhydroxyalkanoate composition. The polyhydroxyalkanoate composition may comprise 100 wt. % or less, such as about 99 wt. % or less, such as about 98 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less of the polyhydroxyalkanoate(s) based on the weight of the polyhydroxyalkanoate composition.

### B. Additives

In addition to the polyhydroxyalkanoate, the polyhydroxyalkanoate composition may optionally comprise one or more additives, such as those mentioned below. In this regard, in one embodiment, the polyhydroxyalkanoate composition may further comprise one or more additives. For instance, the additives may include those typically utilized in the art in order to provide a resulting composition or material (e.g., fiber/filament, yarn, fabric, and/or article) having the desired properties. These additives may include, but are not limited to, fillers, reinforcing agents, process aids, plasticizers, stabilizers (e.g., heat stabilizers; UV light stabilizers; metal deactivators; antioxidants such as phenolic, phosphite, and/or amine containing antioxidants; etc.), viscosity modifiers, lubricants, flow enhancing additives, flame retardants, impact modifiers, antistatic agents, antimicrobial agents, colorants, pigments, etc.

When utilized, the respective additive may be present in the polyhydroxyalkanoate composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more based on the weight of the polyhydroxyalkanoate composition. The respective additive may be present in the polyhydroxyalkanoate composition in an amount of about 20 wt. % or less, such as about 15 wt. % or less, such as about 12 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the polyhydroxyalkanoate composition. In another embodiment, the aforementioned weight percentages may be based on the weight of the polyhydroxyalkanoate(s) in the polyhydroxyalkanoate composition. In addition, it should be understood that in one embodiment, a respective additive may be present in the polyhydroxyalkanoate composition in an amount of 0 wt. %.

In addition to the polyhydroxyalkanoate, the polyhydroxyalkanoate composition may include other polymers in certain embodiments. For instance, the additional polymer may be a polyester, a polyamide, etc. in one embodiment. In one particular embodiment, the additional polymer may be a polyester. For instance, the polyester may be polyethylene terephthalate, polylactic acid, or a mixture thereof. In one embodiment, the additional polymer may be polyethylene terephthalate. In another embodiment, the additional polymer may be polylactic acid.

When utilized, the additional polymer may be present in the polyhydroxyalkanoate composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more, such as about 8 wt. % or more based on the weight of the polyhydroxyalkanoate composition. The additional polymer may be present in the polyhydroxyalkanoate composition in an amount of about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the polyhydroxyalkanoate composition. In another embodiment, the aforementioned weight percentages may be based on the weight of the polyhydroxyalkanoate(s) in the polyhydroxyalkanoate composition. In addition, it should be understood that in one embodiment, a respective additional polymer may be present in the polyhydroxyalkanoate composition in an amount of 0 wt. %.

However, as indicated above, in certain embodiments, of the polymers present in the polyhydroxyalkanoate fibers and/or yarns and the polyhydroxyalkanoate composition as disclosed herein for making the polyhydroxyalkanoate fiber and/or yarn, the polyhydroxyalkanoate(s) may constitute a primary concentration of such respective fiber and/or yarn and composition. For instance, in one embodiment, of the polymers present, the polyhydroxyalkanoate(s) may constitute 80 wt. % or more, such as 85 wt. % or more, such as 90 wt. % or more, such as 92 wt. % or more, such as 94 wt. % or more, such as 95 wt. % or more, such as 96 wt. % or more, such as 97 wt. % or more, such as 98 wt. % or more, such as 98.5 wt. % or more, such as 99 wt. % or more, such as 99.5 wt. % or more, such as 99.8 wt. % or more, such as 99.9 wt. % or more, such as 99.99 wt. % or more of the polymers present, whether in such polyhydroxyalkanoate fiber or the polyhydroxyalkanoate composition. In some embodiments, the polyhydroxyalkanoate(s) may constitute 100 wt. % of the polymers present in the polyhydroxyalkanoate fiber and the polyhydroxyalkanoate composition.

### II. Composition Formation

The polyhydroxyalkanoate composition described herein can be processed using techniques generally known in the art. For instance, the components (polyhydroxyalkanoate and optional additives) may be melt-mixed (also referred to as melt-blended). Utilizing such an approach, the components may be well-dispersed throughout the composition.

Prior to such melt-blending, any respective components may also be dried in order to minimize any moisture content. The drying may be conducted using means generally known in the art. In addition, during drying, a vacuum may be utilized to assist in removing any moisture content.

For instance, the total moisture content of the components provided for melt-blending may be 5000 ppm or less, such as 4500 ppm or less, such as 4000 ppm or less, such as 3500 ppm or less, such as 3000 ppm or less, such as 2500 ppm or less, such as 2000 ppm or less, such as 1800 ppm or less, such as 1500 ppm or less, such as 1300 ppm or less, such as 1000 ppm or less, such as 800 ppm or less, such as 600 ppm or less, such as 500 ppm or less, such as 400 ppm or less, such as 300 ppm or less, such as 200 ppm or less, such as 100 ppm or less, such as 50 ppm or less.

In one embodiment, such aforementioned moisture content may simply apply to the moisture content of the polyhydroxyalkanoate(s) utilized. In this regard, the moisture content of the polyhydroxyalkanoate(s) provided for melt-blending may be 5000 ppm or less, such as 4500 ppm or less, such as 4000 ppm or less, such as 3500 ppm or less, such as 3000 ppm or less, such as 2500 ppm or less, such as 2000 ppm or less, such as 1800 ppm or less, such as 1500 ppm or less, such as 1300 ppm or less, such as 1000 ppm or less, such as 800 ppm or less, such as 600 ppm or less, such as 500 ppm or less, such as 400 ppm or less, such as 300 ppm or less, such as 200 ppm or less, such as 100 ppm or less, such as 50 ppm or less.

Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, an extruder, such as a co-rotating extruder, a counter-rotating extruder, or a twin-screw extruder, a co-kneader, etc. The melt blending may be carried out at a temperature greater than the melting temperature of the polyhydroxyalkanoate and generally less than a degradation temperature. For instance, the temperature may range from 50° C. to 300° C., such as from 80° C. to 200° C., such as 80° C. to 150° C., such as 90° C. to 150° C., such as 100° C. to 150° C., such as 110° C. to 150° C. However, such processing should be conducted for each respective composition at a desired temperature to minimize any degradation. Upon completion of the mixing/blending, the composition may be milled, chopped, extruded, pelletized, or processed by any other desirable technique. In certain instances, the components may be melt-blended and directly fed to a downstream operation, such as a spinneret for forming fibers (interchangeably referred to as filaments) and yarns as disclosed herein. In particular, once formed, the polyhydroxyalkanoate composition may be utilized to form fibers (or filaments) and yarns as further described herein.

### III. Fibers and Yarns

As indicated herein, the polyhydroxyalkanoate and corresponding composition are suitable for forming fibers and corresponding yarns. In particular, the polyhydroxyalkanoate and corresponding composition may be utilized to form continuous fibers (or filaments) and corresponding yarns. For instance, the properties of the polyhydroxyalkanoate allow it to be processed to form fibers/filaments at speeds and conditions as disclosed herein and thereafter allow the fibers/filaments to be processed to form yarns and resulting fabrics and articles.

Furthermore, in one embodiment, the yarn may be a monofilament (or monofiber) yarn. In this regard, the yarn may simply be formed from the polyhydroxyalkanoate and/or corresponding composition. In another embodiment, the yarn may be a multifilament (or multifiber) yarn. In this regard, the yarn may also be formed from the polyhydroxyalkanoate and/or corresponding composition. In one embodiment, such multifilament yarn may include a second type of material. For instance, such second type of material may be any material generally known in the art for forming fibers/filaments and yarns.

The fibers/filaments of the present disclosure can be made using conventional processes known in the art. For example, these processes may include general steps such as spinning and optionally drawing the polyhydroxyalkanoate composition, including the polyhydroxyalkanoate, into a fiber/filament. The fibers/filaments may also be treated mechanically and/or chemically to impart desirable characteristics depending on the desired properties and characteristics of the resulting article made from the fibers/filaments and yarns.

In one particular embodiment, the fibers/filaments may be formed via melt spinning. Accordingly, the fibers/filaments may be melt spun fibers/filaments. Generally, melt spinning includes heating the polyhydroxyalkanoate and corresponding composition including the polyhydroxyalkanoate to form a melt (also referred to as a polymer melt) wherein such melting can be conducted by heating the polyhydroxyalkanoate against a heated surface. As an example, the polyhydroxyalkanoate may be heated in a mixer or an extruder and thereafter provided or metered to a spinneret. The temperature of operation may correspond to the melting temperature of the polyhydroxyalkanoate; for instance, the temperature may be relatively higher than the melting temperature of the polyhydroxyalkanoate in order to allow for the formation of a polymer melt. Regardless, the operation temperature may be within the ranges of the melting temperature of the polyhydroxyalkanoate as defined above.

The spinneret may include a plurality of orifices or capillaries having a particular size and design that allows for the formation of a fiber/filament having the desired configuration and cross-section. Accordingly, this process allows fibers/filaments of various sizes and cross sections to be formed, including fibers/filaments having, for example, round, elliptical, square, rectangular, lobed or dog-boned cross sections, etc.

The polyhydroxyalkanoate can be spun at speeds of from about 200 to about 6000 meters per minute (m/min), depending on the desired fiber/filament size. When forming the fibers/filaments, the spinning speed may be at least about 200 m/min, such as at least about 400 m/min, such as at least about 500 m/min, such as at least about 600 m/min, such as at least about 800 m/min, such as at least about 1000 m/min, such as at least about 2000 m/min. The spinning speed may be about 6000 m/min or less, such as about 5000 m/min or less, such as about 4000 m/min or less, such as about 3000 m/min or less, such as about 2500 m/min or less, such as about 2000 m/min or less, such as about 1800 m/min or less, such as about 1600 m/min or less, such as about 1400 m/min or less, such as about 1200 m/min or less, such as about 1000 m/min or less.

Once extruded through the spinneret, the fibers/filaments may be quenched. For instance, the fibers/filaments can be contacted with a non-reactive gas stream (e.g., air) or a liquid (e.g., water) to assist in solidifying the fibers/filaments. As an example, a fiber/filament may be quenched using a non-reactive gas stream, such as air. In another embodiment, quenching may be conducted using a liquid, such as water. The water may be cold water, such as having a temperature of 15° C. or less, such as 10° C. or less, such as 5° C. or less, such as 0° C. or less. In certain embodiments, both air quenching and liquid quenching may be utilized. For instance, air quenching may be conducted first followed by liquid quenching. In other embodiments, liquid quenching may be conducted first followed by air quenching. In addition, in one embodiment, additional quenching may not be necessary and sufficient quenching may be conducted based on ambient conditions. Thereafter, the fibers/filaments are collected downstream from the spinneret using one or more rollers.

Following extrusion from the spinneret, the fiber/filament may be drawn. The drawing may assist with achieving desirable properties, such as increasing modulus, strength, etc. However, it should be understood that in certain embodiments, drawing may not be conducted such that the fiber/filament produced is an undrawn fiber/filament. In such embodiments, the fiber/filament may still nonetheless have certain desirable properties. When conducted, the drawing can be done in combination with take-up by using a series of rollers or it can be done as a separate stage in the process of the fiber/filament formation.

The fibers/filaments may be drawn at any desired draw ratio depending on the desired properties, short of that which interferes with processing by breaking a fiber/filament. In this regard, the fibers/filaments may be drawn from 0× to about 10×, such as from about 0.5× to about 10×, such as from about 1.0× to about 10×. For instance, the fibers/filaments may be drawn at 0× or more, such as at least about 0.1×, such as at least about 0.2×, such as at least about 0.3×, such as at least about 0.5×, such as at least about 0.7×, such as at least about 0.9×, such as at least about 1.1×, such as at least about 1.2×, such as at least about 1.3×, such as at least about 1.4×, such as at least about 1.5×, such as at least about 1.8×, such as at least about 2×, such as at least about 2.2×, such as at least about 2.4×, such as at least about 2.5×, such as at least about 2.8×, such as at least about 3×, such as at least about 3.5×, such as at least about 4×, such as at least about 4.5×, such as at least about 5×, such as at least about 6×, such as at least about 8×. The fibers/filaments may be drawn about 10× or less, such as about 9× or less, such as about 8× or less, such as about 7.5× or less, such as about 7× or less, such as about 6.5× or less, such as about 6× or less, such as about 5.5× or less, such as about 5× or less, such as about 4.5× or less, such as about 4× or less, such as about 3.5× or less, such as about 3× or less, such as about 2.8× or less, such as about 2.6× or less, such as about 2.4× or less, such as about 2.2× or less, such as about 2× or less, such as about 1.8× or less, such as about 1.6× or less, such as about 1.4× or less, such as about 1.2× or less, such as about 1× or less, such as about 0.8× or less, such as about 0.6× or less, such as about 0.4× or less, such as about 0.2× or less. Such drawing may be conducted in a single step draw in one embodiment. In another embodiment, however, the fibers/filaments may not be drawn.

The drawing may be conducted at ambient conditions in one embodiment. In another embodiment, the drawing may be conducted at an elevated temperature. The temperature may be 20° C. or more, such as 22° C. or more, such as 24° C. or more, such as 25° C. or more, such as 30° C. or more, such as 40° C. or more, such as 45° C. or more, such as 60° C. or more, such as 65° C. or more, such as 70° C. or more, such as 80° C. or more, such as about 90° C. or more, such as about 100° C. or more, such as about 110° C. or more, such as about 120° C. or more, such as about 130° C. or more, such as about 140° C. or more, such as about 150° C. or more. The temperature may be about 200° C. or less, such as about 190° C. or less, such as about 180° C. or less, such as about 170° C. or less, such as about 160° C. or less, such as about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 50° C. or less. In other words, the fiber/filament may be subjected to such temperature prior to the actual drawing conducted.

At such elevated temperature, the polyhydroxyalkanoate fiber and/or yarn may undergo a relaxation treatment. As indicated herein and without intending to be limited by theory, such relaxation may allow for the polymer chains of the polyhydroxyalkanoate to relax. In this regard, such relaxation may result in an increase in the crystallinity of the polyhydroxyalkanoate such that the polyhydroxyalkanoate chains better align and may be less amorphous.

The relaxation treatment can be conducted on the fiber and/or yarn at various stages of formation and processing. For instance, it may be conducted prior to being wound onto a winding roller in one embodiment. In particular, it may be conducted prior to drawing such that the relaxation may assist with the drawing in a subsequent step in one embodiment.

In addition, the relaxation treatment may be conducted using general relaxation treatment techniques generally known in the art. Further, any amount of relaxation can be carried out and is not necessarily limited by the present disclosure. In one embodiment, the relaxation treatment may be a heat treatment. For instance, such treatment may include contacting or subjecting the polyhydroxyalkanoate fiber and/or yarn to heat, such as an elevated temperature.

In general, the relaxation treatment may be conducted by subjecting the polyhydroxyalkanoate fiber and/or yarn to a certain temperature. By subjecting, it may be understood that this may cover various methods of providing such increased temperature.

In this regard, the heat treatment can be carried out using means generally known in the art. For instance, the fiber and/or yarn may be dry or wet heat-treated while relaxed to develop the desired properties. The heating medium is not necessarily limited. For instance, it may include air, such as dry air or steam in one embodiment. In another embodiment, it may include a liquid, such as water.

The heat-treating/relaxation step can generally be accomplished in a few seconds. Such treatment may be for 0.5 seconds or more, such as 1 second or more, such as 2 seconds or more, such as 3 seconds or more, such as 4 seconds or more, such as 5 seconds or more, such as 8 seconds or more, such as 10 seconds or more, such as 15 seconds or more, such as 20 seconds or more, such as 25 seconds or more, such as 30 seconds or more, such as 40 seconds or more, such as 50 seconds or more, such as 1 minute or more, such as 2 minutes or more, such as 5 minutes or more, such as 10 minutes or more, such as 15 minutes or more, such as 20 minutes or more, such as 25 minutes or more, such as 30 minutes or more, such as 45 minutes or more, such as 1 hour or more, such as 1.25 hours or more, such as 1.5 hours or more, such as 1.75 hours or more, such as 2 hours or more. The treatment may be for 10 hours or less, such as 8 hours or less, such as 6 hours or less, such as 5 hours or less, such as 4 hours or less, such as 3 hours or less, such as 2.5 hours or less, such as 2 hours or less, such as 1.75 hours or less, such as 1.5 hours or less, such as 1.25 hours or less, such as 1 hour or less, such as 50 minutes or less, such as 40 minutes or less, such as 30 minutes or less, such as 20 minutes or less, such as 10 minutes or less, such as 5 minutes or less, such as 3 minutes or less, such as 2 minutes or less, such as 1 minute or less, such as 50 seconds or less, such as 40 seconds or less, such as 30 seconds or less, such as 20 seconds or less, such as 15 seconds or less, such as 10 seconds or less, such as 8 seconds or less, such as 5 seconds or less, such as 4 seconds or less, such as 3 seconds or less, such as 2 seconds or less.

Without intending to be limited, as indicated above, the relaxation may allow the polyhydroxyalkanoate chains to better align and thereby be less amorphous. In this regard, the polyhydroxyalkanoate of the “initial” polyhydroxyalkanoate fiber and/or yarn may undergo shrinkage. Similarly, the “initial” polyhydroxyalkanoate fiber and/or yarn may undergo shrinkage compared to the “final” relaxed polyhydroxyalkanoate fiber and/or yarn. In this regard, the shrinkage may be 1% or more, such as 2% or more, such as 3% or more, such as 4% or more, such as 5% or more, such as 8% or more, such as 10% or more, such as 15% or more, such as 20% or more, such as 25% or more, such as 30% or more, such as 35% or more, such as 40% or more, such as 45% or more, such as 50% or more. The shrinkage may be 80% or less, such as 75% or less, such as 70% or less, such as 65% or less, such as 60% or less, such as 55% or less, such as 50% or less, such as 45% or less, such as 40% or less, such as 35% or less, such as 30% or less, such as 25% or less, such as 20% or less, such as 15% or less, such as 10% or less. The shrinkage may be determined by measuring a length of a polyhydroxyalkanoate fiber and/or yarn pre-and post-relaxation and measuring the percent shrinkage of such fiber and/or yarn.

The fibers/filaments may be drawn in at least one drawing step, for example between a first roll, such as a feed roll, (which can be operated at 150 to 1000 m/minute) and a second roll, such as a draw roll, to form a drawn fiber/filament. In this regard, the aforementioned heat treatment/exposure to elevated temperature may be conducted between such rolls. The drawing step can be coupled with spinning to make a drawn yarn. Herein, the draw ratio may be the draw roll peripheral speed divided by the feed roll peripheral speed.

The quenched, optionally drawn, fibers/filaments can then be collected by winding at a winder. The winder (or winder roller) may also be referred to as a take up roll. The winding speed may be from about 200 to about 6000 meters per minute (m/min). For instance, the winding speed may be at least about 200 m/min, such as at least about 400 m/min, such as at least about 500 m/min, such as at least about 600 m/min, such as at least about 800 m/min, such as at least about 1000 m/min, such as at least about 1250 m/min, such as at least about 1500 m/min, such as at least about 1750 m/min, such as at least about 2000 m/min. The winding speed may be about 6000 m/min or less, such as about 5000 m/min or less, such as about 4000 m/min or less, such as about 3000 m/min or less, such as about 2750 m/min or less, such as about 2500 m/min or less, such as about 2250 m/min or less, such as about 2000 m/min or less, such as about 1800 m/min or less, such as about 1600 m/min or less, such as about 1400 m/min or less, such as about 1200 m/min or less, such as about 1000 m/min or less.

The resulting fiber/filament and/or yarn is also amenable to further processing through the use of additional processing equipment, or it may be used directly in applications requiring a continuous fiber/filament and/or yarn. Regarding further processing, the fiber/filament and/or yarn subsequently may be textured through known texturing conditions or processes. It may also be desirable to increase the surface area of the fiber/filament and/or yarn to provide a softer feel and to enhance the ability to breathe, thereby providing better insulation and water retention in the case of textiles. To increase the surface area, the fiber/filament and/or yarn may be crimped or twisted using techniques generally known in the art. Any additional processing methods utilized may be dictated by the particular application for the fiber/filament.

In addition, after formation, the fiber/filament and/or yarn may be treated by any method appropriate for the desired final use. For instance, in particular regarding textiles, this may include dyeing, coloring with pigments, sizing, or the addition of chemical agents such as antistatic agents, flame retardants, UV light stabilizers, antioxidants, pigments, dyes, stain resistants, and/or antimicrobial agents. In addition, the fibers/filaments and/or yarn may be treated to impart additional desired characteristics such as strength, elasticity or shrinkage.

While the fibers/filaments and yarns may be treated using such techniques, it should be understood that the resulting article, such as a fabric or textile, may also be treated using such techniques. For instance, while any independent treatment may be conducted on the fiber/filament during processing or post-processing, it should be understood that any such methods may also be conducted on a resulting article, such as a fabric or textile/article made from such fabric.

Generally, the method of making a fiber/filament or a yarn, such as a monofilament yarn, as disclosed herein may include at least the following: extruding a melt comprising the polyhydroxyalkanoate composition comprising the polyhydroxyalkanoate through a spinneret; withdrawing a fiber/filament from the spinneret; and collecting the fiber/filament on a roller, such as a winding roller. In addition, the method may also comprise quenching the fiber/filament. Such quenching may be conducted before drawing, if drawing is conducted, the fiber/filament. In certain embodiments, such quenching may simply be under ambient conditions. Also, the method may include a step of drawing the fiber/filament using a roller, such as a draw roller. Such drawing may be conducted after quenching.

Further, generally, the method of making a multifilament yarn as disclosed herein may include at least the following: extruding a melt comprising the polyhydroxyalkanoate composition comprising the polyhydroxyalkanoate through a spinneret; withdrawing a first fiber/filament and a second fiber/filament from the spinneret; and collecting the first fiber/filament and the second fiber/filament on a roller, such as a winding roller. In addition, the method may also comprise quenching the first fiber/filament and the second fiber/filament. Such quenching may be conducted before drawing, if drawing is conducted, the fiber/filament. In certain embodiments, such quenching may simply be under ambient conditions. Also, the method may include a step of drawing the first fiber/filament and the second fiber/filament using a roller, such as a draw roller. Such drawing may be conducted after quenching.

In addition, the method of making the multifilament yarn may also include a step of converging the fibers/filaments to form the multifilament yarn. Such converging of fibers/filaments may be conducted at any step of the process. In some embodiments, it may be conducted prior to being collected in a winding roll. For instance, it may be conducted after spinning, in particular after quenching. In one embodiment, it may be conducted after drawing. In another embodiment, it may be conducted before drawing. In other embodiments, the yarn may be prepared post collection on a winding roll, such that it is a post manufacturing process.

However, it should be understood that other methods of making multifilament yarns as known in the art may also be utilized. For instance, such methods may be utilized when the fibers/filaments of the multifilament yarn are formed from different materials. For instance, as indicated here, a respective yarn may include a first fiber formed from a fiber-forming material and a second fiber formed from a polyhydroxyalkanoate. In this regard, separate monofilaments or fibers of the first fiber as mentioned herein and a second fiber of the polyhydroxyalkanoate may be formed. Then, post formation, such respective fibers may be spun to form a respective multifilament yarn.

Further in accordance with the present disclosure, a melt spinning process is also disclosed for spinning fibers/filaments, in particular continuous fibers/filaments. In general, the process comprises passing a melt comprising a polyhydroxyalkanoate composition, including a polyhydroxyalkanoate, through a spinneret to form a plurality of fibers/filaments. A polyhydroxyalkanoate composition supply (e.g., in granular, pellet, or other form such as a melt) may be introduced to a spinneret. The molten fibers/filaments may be extruded through the spinneret. The polyhydroxyalkanoate may be extruded as undrawn fibers/filaments from the spinneret having orifices designed to give a desired cross section. In addition, the process may further include quenching the fibers/filaments after they exit the capillary of the spinneret to cool and/or solidify the fibers/filaments in any known manner, for example by air. Any suitable quenching method may be used. In one embodiment, the quenching may not be via forced air quenching; it may simply be conducted in ambient conditions.

As indicated herein, the fibers/filaments may be utilized to make a yarn. A yarn may include, but is not limited to, a number of fibers/filaments twisted together (spun yarn), a number of fibers/filaments laid together without twist (a zero-twist yarn), a number of fibers/filaments laid together with a degree of twist, and a single fiber/filament with or without twist (a monofilament).

In one embodiment, a multifilament yarn as disclosed herein may have no twist. In another embodiment, the multifilament yarn as disclosed herein may have a relatively small degree of twist. For instance, the twist may be 1 or less twists per inch, such as 0.9 or less twists per inch, such as 0.8 or less twists per inch, such as 0.7 or less twists per inch, such as 0.6 or less twists per inch, such as 0.5 or less twists per inch, such as 0.4 or less twists per inch, such as 0.3 or less twists per inch, such as 0.2 or less twists per inch, such as 0.1 or less twists per inch, such as 0.05 or less twists per inch, such as 0.01 or less twists per inch. The twist may be 0 or more twists per inch, such as 0.01 or more twists per inch, such as 0.05 or more twists per inch, such as 0.1 or more twists per inch, such as 0.2 or more twists per inch, such as 0.3 or more twists per inch, such as 0.4 or more twists per inch, such as 0.5 or more twists per inch.

As indicated herein, the yarn may generally have any fiber/filament count. For instance, the yarn may be a monofilament yarn formed from a single fiber/filament. Alternatively, the yarn may be a multifilament yarn formed from two or more fibers/filaments wherein such two or more fibers/filaments may be wound to form the yarn. Accordingly, the multifilament yarn comprises a first fiber/filament and a second fiber/filament. In addition, the multifilament yarn may further comprise a third fiber/filament. In particular, the multifilament yarn may include a first fiber/filament, a second fiber/filament, and a third fiber/filament. In one embodiment, the fibers/filaments of the multifilament yarn may be formed from the same material.

In this regard, the multifilament yarn may comprise at least about 2 fibers/filaments. The multifilament yarns may comprise about 2 or more, such as about 3 or more, such as about 5 or more, such as about 10 or more, such as about 15 or more, such as about 20 or more, such as about 25 or more, such as about 50 or more, such as about 100 or more fibers/filaments. The multifilament yarn may comprise about 200 or less, such as about 100 or less, such as about 80 or less, such as about 60 or less, such as about 50 or less, such as about 40 or less, such as about 35 or less, such as about 30 or less, such as about 25 or less, such as about 20 or less, such as about 15 or less, such as about 10 or less, such as about 5 or less, such as about 4 or less, such as about 3 or less fibers/filaments.

The yarns may have a total denier of from about 1 to about 2000. For instance, the total denier may be about 1 or more, such as about 5 or more, such as about 10 or more, such as about 20 or more, such as about 30 or more, such as about 40 or more, such as about 50 or more, such as about 70 or more, such as about 100 or more, such as about 120 or more, such as about 140 or more, such as about 160 or more, such as about 180 or more, such as about 200 or more, such as about 300 or more, such as about 500 or more, such as about 800 or more, such as about 1000 or more, such as about 1300 or more, such as about 1500 or more, such as about 1800 or more, such as about 2000 or more. The total denier may be about 3000 or less, such as about 2800 or less, such as about 2500 or less, such as about 2200 or less, such as about 2000 or less, such as about 1800 or less, such as about 1600 or less, such as about 1400 or less, such as about 1200 or less, such as about 1000 or less, such as about 800 or less, such as about 600 or less, such as about 500 or less, such as about 450 or less, such as about 400 or less, such as about 350 or less, such as about 300 or less, such as about 275 or less, such as about 250 or less, such as about 225 or less, such as about 200 or less, such as about 180 or less, such as about 160 or less, such as about 140 or less, such as about 120 or less, such as about 100 or less, such as about 80 or less, such as about 60 or less, such as about 50 or less. The denier may be determined in accordance with D2259-02(2016) at a temperature of about 23° C.

In other words, the denier per filament (or fiber) may be 0.5 or more, such as 1 or more, such as 1.5 or more, such as 2 or more, such as 2.5 or more, such as 3 or more, such as 3.5 or more, such as 4 or more, such as 4.5 or more, such as 5 or more, such as 5.5 or more, such as 6 or more, such as 7 or more, such as 8 or more, such as 10 or more, such as 15 or more, such as 20 or more, such as 25 or more, such as 30 or more, such as 40 or more, such as 50 or more, such as 80 or more, such as 100 or more, such as 130 or more, such as 150 or more, such as 180 or more, such as 200 or more, such as 230 or more, such as 250 or more. The denier per filament (or fiber) may be 300 or less, such as 280 or less, such as 260 or less, such as 240 or less, such as 220 or less, such as 200 or less, such as 180 or less, such as 160 or less, such as 140 or less, such as 120 or less, such as 100 or less, such as 90 or less, such as 80 or less, such as 70 or less, such as 60 or less, such as 50 or less, such as 40 or less, such as 30 or less, such as 25 or less, such as 20 or less, such as 15 or less, such as 10 or less, such as 8 or less, such as 7 or less, such as 6 or less, such as 5 or less, such as 4 or less, such as 3 or less, such as 2 or less. The denier per filament may be determined in accordance with D2259-02(2016) at a temperature of about 23° C.

The fiber/filament may have a particular size. For instance, the size may be 0.1 mm or more, such as 0.2 mm or more, such as 0.3 mm or more, such as 0.4 mm or more, such as 0.5 mm or more, such as 0.6 mm or more, such as 0.7 mm or more, such as 0.8 mm or more, such as 0.9 mm or more, such as 1 mm or more. The size may be 5 mm or less, such as 4.5 mm or less, such as 4 mm or less, such as 3.5 mm or less, such as 3 mm or less, such as 2.5 mm or less, such as 2 mm or less, such as 1.8 mm or less, such as 1.6 mm or less, such as 1.5 mm or less, such as 1.4 mm or less, such as 1.3 mm or less, such as 1.2 mm or less, such as 1.1 mm or less, such as 1 mm or less, such as 0.9 mm or less, such as 0.8 mm or less, such as 0.7 mm or less, such as 0.6 mm or less, such as 0.5 mm or less, such as 0.4 mm or less, such as 0.3 mm or less, such as 0.2 mm or less. In one embodiment, such aforementioned size may refer to the size of the yarn.

### IV. Fabrics

As indicated herein, the polyhydroxyalkanoate fiber and/or yarn may be utilized in a fabric thereby allowing the fabric utilized to form various articles for various applications. In general, the fabric may be formed from a plurality of fibers and/or yarns. For instance, the fibers may include a polyhydroxyalkanoate fiber as disclosed herein. In this regard, a majority of the fabric and fibers of such fabric may be formed from a polyhydroxyalkanoate.

In one embodiment, the fabric may include a plurality of fibers and/or yarns. For instance, the fabric may include a first fiber formed from a fiber-forming material and a second fiber formed from a polyhydroxyalkanoate. The fiber-forming material for the first fiber may be any material generally known in the art for forming fibers/filaments and yarns. In one embodiment, it may be a thermoplastic material. In another embodiment, it may be an elastic material. In another embodiment, it may be a non-elastic material. In one embodiment, the fiber-forming material may not be a polyhydroxyalkanoate. In this regard, the fiber-forming material may be a non-polyhydroxyalkanoate. The fiber-forming material may be cellulosic (e.g., cotton), proteinaceous (e.g., wool, silk), polyester (e.g., polyethylene terephthalate, polytrimethylene terephthalate), polyamide (e.g., nylon, polycaprolactam, poly(hexamethylene adipamide), aramid), acrylic, acetate, rayon, etc. In one embodiment, the fiber-forming material may be a polyhydroxyalkanoate. However, such polyhydroxyalkanoate may have a higher melting temperature than the polyhydroxyalkanoate of the second fiber.

Further, the fiber-forming material may be a thermoplastic in one embodiment, such that it has a glass transition temperature and/or a melting temperature. In another embodiment, the fiber-forming material may be a thermoset such that it has a degradation temperature. Regardless, the fiber-forming material has a melting temperature and/or a degradation temperature.

In this regard, the fiber-forming material may have a melting temperature or degradation temperature higher than the melting temperature of the polyhydroxyalkanoate. For instance, the fiber-forming material may have a melting temperature that is at least 20° C., such as at least 30° C., such as at least 40° C., such as at least 50° C., such as at least 60° C., such as at least 70° C., such as at least 80° C., such as at least 90° C., such as at least 100° C. greater than the melting temperature of the polyhydroxyalkanoate. The melting temperature of the fiber-forming material may be within 200° C. greater, such as within 180° C. greater, such as within 160° C. greater, such as within 140° C. greater, such as within 120° C. greater, such as within 100° C. greater, such as within 80° C. greater, such as within 60° C. greater than the melting temperature of the polyhydroxyalkanoate. In the event the material is not a thermoplastic, the degradation temperature of such fiber-forming material may be at least 20° C., such as at least 30° C., such as at least 40° C., such as at least 50° C., such as at least 60° C., such as at least 70° C., such as at least 80° C., such as at least 90° C., such as at least 100° C. greater than the melting temperature of the polyhydroxyalkanoate. The degradation temperature of the fiber-forming material may be within 200° C. greater, such as within 180° C. greater, such as within 160° C. greater, such as within 140° C. greater, such as within 120° C. greater, such as within 100° C. greater, such as within 80° C. greater, such as within 60° C. greater than the melting temperature of the polyhydroxyalkanoate.

The fibers/filaments and/or yarns formed from the fiber-forming material can be made using conventional processes known in the art. For example, these processes may include general steps such as spinning and optionally drawing the fiber-forming material into a fiber/filament. The fibers/filaments may also be treated mechanically and/or chemically to impart desirable characteristics such as strength, elasticity, heat resistance, feel, etc. depending on the desired properties and characteristics of the resulting article made from the fibers/filaments and yarns.

Such plurality of fibers may be presented in various configurations. For example, in one embodiment, a yarn, such as a first yarn, may be provided including the first fiber formed from a fiber-forming material and the second fiber formed from a polyhydroxyalkanoate. Accordingly, such single yarn may include both types of fibers. In another embodiment, the fabric may include two yarns. For instance, it may include a first yarn and a second yarn. The first yarn may include a plurality of fibers including a first fiber formed from a fiber-forming material. The second yarn may include a second fiber formed from a polyhydroxyalkanoate. In one embodiment, the second yarn may also include a plurality of fibers including a second fiber formed from a polyhydroxyalkanoate. Accordingly, such respective fibers may be present in the fabric in various configurations.

Regardless, the resulting fibers and/or yarns may include a polyhydroxyalkanoate-based fiber and/or yarn in a particular amount. For instance, the polyhydroxyalkanoate may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the yarn. The polyhydroxyalkanoate may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less. In one embodiment, the aforementioned may be based on the weight of the fibers. In another embodiment, the aforementioned may be based on the weight of a fabric.

Nevertheless, the fibers/filaments may be utilized to form yarns which may be used to prepare woven, knit, and/or nonwoven fabrics and resulting articles which can be prepared using conventional techniques including, but not limited to, meltblown, spunbonded, card and bond, air entanglement, and other techniques. For instance, they may be subjected to various high-speed conditions for the formation of such articles.

In addition, the configuration of the yarn may depend on the particular application. For instance, the yarn may be utilized as a bare yarn or a covered yarn. In one embodiment, the yarns may be utilized themselves as bare yarns. Alternatively, the yarns may be used as covered yarns wherein the yarn as described herein may be utilized as the core. For such covered yarn, an inelastic fiber/filament or yarn or a short fiber yarn may wrap the core, in particular in a spiral manner. In addition or alternatively, another elastic yarn may also be utilized to cover.

Further, the yarns may be utilized to make fabrics, such as knit fabrics or woven fabrics. Further, the knit construction of the fabrics using the yarns is not necessarily limited by the present disclosure. For instance, various types of knit constructions as known in the art may be utilized to form a fabric and/or resulting article utilizing the fibers/filaments and yarns as disclosed herein. As one example, the knit construction may be a circular knit construction.

Generally, knitting is a process for constructing a fabric by interlocking a series of loops (bights) of one or more strands organized in wales and courses. In general, knitting includes warp knitting and weft knitting. In warp knitting, a plurality of strands runs lengthwise in the fabric to make all the loops. In weft knitting, one continuous strand runs crosswise in the fabric, making all the loops in one course. Weft knitting includes fabrics formed on both circular knitting and flat knitting machines. With circular knitting machines, the fabric is produced in the form of a tube, with the strands running continuously around the fabric. With a flat knitting machine, the fabric is produced in flat form, the threads alternating back and forth across the fabric. The resulting textile includes an interior side (the technical back) and an exterior side (the technical face), each layer being formed of the same or varying strands and/or stitches. By way of example, the knit structure may be a single knit/jersey fabric, a double knit/jersey fabric, and/or a plated fabric (with yarns of different properties are disposed on the face and back).

Within the strands, fibers/filaments and/or yarns other than those disclosed herein may be incorporated. For instance, the knit structure may include strands of the first fiber of a fiber-forming material and a second fiber of a polyhydroxyalkanoate as disclosed herein. However, the knit structure may also include strands of other materials than disclosed herein.

In other words, a strand may include a plurality of fibers. Such plurality of fibers may include a polyhydroxyalkanoate. In one embodiment, such plurality of fibers may include a first fiber of a fiber-forming material and a second fiber of a polyhydroxyalkanoate as disclosed herein. In one embodiment, the strand may include a first yarn and a second yarn, wherein such yarns are brought together to form the fabric. The first yarn may include a plurality of fibers including a first fiber formed from a fiber-forming material. The second yarn may include a second fiber formed from a polyhydroxyalkanoate. In one embodiment, the second yarn may also include a plurality of fibers including a second fiber formed from a polyhydroxyalkanoate. Accordingly, such respective fibers may be present in the fabric in various configurations.

Particularly, with respect to one embodiment of a fabric structure as disclosed herein, a loop may include a plurality of fibers. Such plurality of fibers may include a polyhydroxyalkanoate fiber as disclosed herein. In one embodiment, the plurality of fibers may include a first fiber of a fiber-forming material and a second fiber of a polyhydroxyalkanoate as disclosed herein. In one embodiment, the loop may include a first yarn and a second yarn, wherein such yarns are brought together to form the fabric. The first yarn may include a plurality of fibers including a first fiber formed from a fiber-forming material. The second yarn may include a second fiber formed from a polyhydroxyalkanoate. In one embodiment, the second yarn may also include a plurality of fibers including a second fiber formed from a polyhydroxyalkanoate. Accordingly, such respective fibers may be present in the fabric in various configurations.

As indicated, other types of strands and yarns may also be utilized. For instance, in the knit structure, in one embodiment, at least one strand may be another strand typically used in the art. For instance, such strand may be formed of a synthetic material. Such strand may be formed from an elastic and may be any as generally known in the art. Alternatively, in one embodiment, such strand may be an inelastic strand, typically not formed of an elastomeric material. These strands may include natural fibers including cellulosic fibers (e.g., cotton) and protein fibers (e.g., wool, silk) as well as synthetic fibers including polyester fibers (poly(ethylene terephthalate) fibers and poly(trimethylene terephthalate) fibers), polycaprolactam fibers, poly(hexamethylene adipamide) fibers, acrylic fibers, acetate fibers, rayon fibers, nylon fibers and combinations thereof.

Regardless of the structure (e.g., knit, woven, non-woven), the fabric may include a polyhydroxyalkanoate-based fiber and/or yarn in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The polyhydroxyalkanoate-based fiber and/or yarn may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

Related, the polyhydroxyalkanoate may be present in the fabric in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The polyhydroxyalkanoate may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

### V. Articles

The fabric formed from the fibers/filaments and/or corresponding yarns as disclosed herein can be incorporated into a resulting article. Accordingly, the resulting article may comprise or be formed from the fabric. The article may not necessarily be limited by the present disclosure.

As indicated herein, the fabric may be utilized in a number of articles. Primarily, the fabric may be utilized in articles such as clothing (also referred to as apparel and garments). The clothing may include, but is not limited to, shoes (e.g., shoe uppers), shirts, pants, socks, undergarments, skirts, hats, outerwear, etc. The fabric may also be utilized for other fabric-based goods, particularly soft goods accessories.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention as further described in such appended claims.

1. A method of making a polyhydroxyalkanoate yarn comprising a polyhydroxyalkanoate fiber, the polyhydroxyalkanoate fiber formed by a method comprising:
extruding a polymer melt comprising a polyhydroxyalkanoate composition comprising a polyhydroxyalkanoate through a spinneret;
withdrawing a fiber from the spinneret;
quenching the fiber; and
collecting the fiber on a winding roller;
wherein the yarn exhibits an elongation at break of 50% or more to 1000% or less and a tenacity of 0.1 g/d or more to 4 g/d or less.

2. The method of claim 1, wherein the polyhydroxyalkanoate comprises a homopolymer.

3. The method of claim 1, wherein the polyhydroxyalkanoate comprises a copolymer.

4. The method of claim 1, wherein the polyhydroxyalkanoate has a monomeric unit of the following formula:
—OCR¹R²(CR³R⁴)ₙCO—
wherein
n is an integer; and
R¹, R², R³, and R⁴ independently can be a hydrocarbon radical; a halo-and hydroxy-substituted radical; a hydroxy radical; a halogen radical; a nitrogen-substituted radical; an oxygen-substituted radical; or a hydrogen atom.

5. The method of claim 4, wherein n is from 1 to 3.

6. The method of claim 4, wherein R¹, R², R³, and R⁴ independently can be hydrocarbon radicals or hydrogen atoms.

7. The method of claim 6, wherein the hydrocarbon radical is an alkyl radical.

8. The method of claim 1, wherein the polyhydroxyalkanoate comprises a 3-hydroxybutyrate monomeric unit.

9. The method of claim 1, wherein the polyhydroxyalkanoate comprises poly-3-hydroxybutyrate-co-3-hydroxyhexanoate.

10. The method of claim 1, wherein a plurality of fibers are drawn from the spinneret and the method further comprises a step of converging the plurality of fibers to form the yarn.

11. The method of claim 1, wherein the yarn exhibits an elongation at break of 150% or more to 500% or less.

12. The method of claim 1, wherein the yarn exhibits an elongation at break of 150% or more to 350% or less.

13. The method of claim 1, wherein the yarn exhibits a tenacity of 0.5 g/d or more to 3 g/d or less.

14. The method of claim 1, wherein the yarn exhibits a tenacity of 1 g/d or more to 2 g/d or less.

15. A polyhydroxyalkanoate yarn made according to the method of claim 1.

16. A fabric comprising the polyhydroxyalkanoate yarn of claim 15.

17. The fabric of claim 16, wherein the fabric is a knit fabric.

18. The fabric of claim 16, wherein the fabric is a woven fabric.

19. A polyhydroxyalkanoate yarn comprising a polyhydroxyalkanoate fiber comprising a polyhydroxyalkanoate composition comprising a polyhydroxyalkanoate, wherein the yarn exhibits an elongation at break of 50% or more to 1000% or less and a tenacity of 0.1 g/d or more to 4 g/d or less.

20. The polyhydroxyalkanoate yarn of claim 19, wherein the polyhydroxyalkanoate comprises a homopolymer.

21. The polyhydroxyalkanoate yarn of claim 19, wherein the polyhydroxyalkanoate comprises a copolymer.

22. The polyhydroxyalkanoate yarn of claim 19, wherein the polyhydroxyalkanoate has a monomeric unit of the following formula:
—OCR¹R²(CR³R⁴)ₙCO—
wherein
n is an integer; and
R¹, R², R³, and R⁴ independently can be a hydrocarbon radical; a halo-and hydroxy-substituted radical; a hydroxy radical; a halogen radical; a nitrogen-substituted radical; an oxygen-substituted radical; or a hydrogen atom.

23. The polyhydroxyalkanoate yarn of claim 22, wherein n is from 1 to 3.

24. The polyhydroxyalkanoate yarn of claim 22, wherein R¹, R², R³, and R⁴ independently can be hydrocarbon radicals or hydrogen atoms.

25. The polyhydroxyalkanoate yarn of claim 24, wherein the hydrocarbon radical is an alkyl radical.

26. The polyhydroxyalkanoate yarn of claim 19, wherein the polyhydroxyalkanoate comprises a 3-hydroxybutyrate monomeric unit.

27. The polyhydroxyalkanoate yarn of claim 19, wherein the polyhydroxyalkanoate comprises poly-3-hydroxybutyrate-co-3-hydroxyhexanoate.

28. The polyhydroxyalkanoate yarn of claim 19, wherein the yarn exhibits an elongation at break of 150% or more to 500% or less.

29. The polyhydroxyalkanoate yarn of claim 19, wherein the yarn exhibits an elongation at break of 150% or more to 350% or less.

30. The polyhydroxyalkanoate yarn of claim 19, wherein the yarn exhibits a tenacity of 0.5 g/d or more to 3 g/d or less.

31. The polyhydroxyalkanoate yarn of claim 19, wherein the yarn exhibits a tenacity of 1 g/d or more to 2 g/d or less.
